(19) United States
(12) Patent Application Publication
(10) Pub. No.: US 2021/0311611 A1
(43) Pub. Date: Oct. 7, 2021

(54) DYNAMIC MULTI-AXIS GRAPHICAL USER INTERFACE

(71) Applicant: Google LLC, Mountain View, CA (US)

(72) Inventors: Kerstin Kuehne, London (GB); Jamie Keene, Hertfordshire (GB); Melinda Klayman, London (GB); Ben Davies, London (GB); Nicholas Wilson, Coulsdon (GB); Peter Schiller, Redwood City, CA (US); Radwa Metwali, Mountain View, CA (US); Ibrahim Badr, Zurich (CH)

(21) Appl. No.: 17/122,957

(22) Filed: Dec. 15, 2020

Related U.S. Application Data
(60) Provisional application No. 63/005,689, filed on Apr. 6, 2020.

(51) Int. Cl. G06F 3/0484; G06F 40/123; G06F 16/93; G06F 9/451; G06F 16/248; G06F 16/2457

(52) U.S. Cl. CPC G06F 3/04842; G06F 40/123; G06F 16/24578; G06F 9/451; G06F 16/248; G06F 16/93

(57) ABSTRACT

In various implementations, a multi-axis GUI may be generated for rendition on a display. The GUI may be operable to navigate its focus through an array of selectable tiles along multiple axes. Each of the selectable tiles may be selectable to access a respective document from an online corpus. Based on directional input, the focus of the GUI may be shifted in a direction of the directional input from a first selectable tile to a second selectable tile of the array. Multiple distinct search queries may be formulated based on documents corresponding to the second tile and/or other tiles of the GUI. Sets of document(s) that are responsive to the multiple queries may be obtained and used to generate selectable tiles along axes of the GUI.

### BACKGROUND

When an individual (also referred to herein as a “user”) browses the Internet or other online corpuses of documents, they often follow hyperlinks contained in documents to effectively navigate along a linear “thread” of documents. However, backtracking from that thread into a new thread or into an earlier part of the same thread can be cumbersome, and the user may lose their train of thought and/or become distracted while doing so. Moreover, a user may see multiple different hyperlinks in a single document that are interesting, but if they only follow one hyperlink at a time, they may forget to revisit the other hyperlinks-of-interest later.

Web browser tabs can alleviate these concerns somewhat by allowing a user to open different tabs for different threads. For example, a user can right-click on each hyperlink-of-interest to open a new tab for that document. However, on computing devices with relatively small or otherwise constrained screens—such as mobile phones, or virtual reality (“VR”) or augmented reality (“AR”) headsets—individual tabs are difficult to ascertain and/or interact with, and therefore are often not used. Additionally, when a user follows a hyperlink in a first document to a second document, the user is presented with the second document and the first document is no longer visible.

### SUMMARY

Implementations are described herein that relate to a graphical user interface (“GUI”) that is allows for non-linear browsing of documents or other resources, e.g., during a web browsing session. In various implementations, a GUI generated and/or configured with selected aspects of the present disclosure may include a multi-axis (e.g., multidimensional) array of selectable “tiles,” with each tile being selectable to access a document or other resource. In many cases these documents/resources are “online” resources because they are stored on computing systems that are remote from a client device that renders the GUI, but this is not required.

In various implementations, a user may provide directional input to navigate a “focus” of the GUI through the array of selectable tiles along multiple different axes. As used herein, the “focus” of the GUI refers to the element of the GUI that is presented in a manner meant to draw a user's attention the element. For example, a particular selectable tile that currently the focus may be “foregrounded” relative to other tiles. A tile may be “foregrounded” relative to other tiles in various ways, such as being rendered larger than or more clearly/conspicuously than other tiles, centered on the screen (with other tiles in the margins), occupying the majority of the screen (whereas other tiles occupy only the margins), etc. In some implementations, the selectable tile that is the focus of the GUI may be rendered relatively clearly, whereas other tiles (or at least the visible portions thereof) and/or GUI elements may be rendered slightly blurred. This technique will be referred to herein as the “bokeh” technique (akin to the bokeh technique or “portrait mode” in photography).

User-provided directional input may navigate the focus of the GUI through the multi-axis array of selectable tiles by moving a focus of the GUI along one of the axes, e.g., up, down, left, or right. “Directional input” may include, for instance, a user pressing a directional key on a keyboard, the user selecting a GUI-rendered directional element (e.g., an arrow or GUI button rendered adjacent a focused-upon tile), the user swiping in a direction on an input device such as a touch screen or capacitive touchpad, spoken input that indicates a direction directly or by reference (e.g., “go up,” “tile to the left,” “more from publisher,” etc.), gaze-related input such as a user looking left/right/up/down, a hand gesture captured by one or more sensors, and so forth. As the user navigates the GUI's focus from one selectable tile to another, the first selectable tile may be “backgrounded” and the second selectable tile may be foregrounded. As noted above, the newly-backgrounded selectable tile (and other visible GUI elements/tiles) may be rendered less conspicuously than the in-focus tile, e.g., by making them smaller or by blurring them pursuant to the bokeh technique.

The array of selectable tiles may be dynamic. That is, the selectable tiles that appear adjacent the in-focus selectable tile may be generated and/or regenerated periodically (e.g., after each transition along an axis) based on one or more attributes of the in-focus selectable tile or its underlying document. In some implementations, neighboring selectable tiles may be identified and (re)generated based on search queries (sometimes referred to herein as “pseudo” or “background” queries because they are not explicitly formulated by a user) that are performed based on the in-focus selectable tile's attribute(s). In some such implementations, to generate neighboring tiles for a newly-in-focus selectable tile, multiple distinct search queries may be formulated, e.g., one for each available axis of navigation from the newly-in-focus selectable tile. Multiple sets of search results may be retrieved using these multiple search queries, one set of search results for each distinct search query. A set of search results may include, for instance, a ranked list of responsive documents to the corresponding search query.

The GUI may then be updated to include, along each axis of the multiple axes leading from the newly-in-focus selectable tile, at least one (backgrounded) neighbor tile that corresponds to at least one document of the corresponding set of search results. This document may be, for instance, the top-ranked document of the corresponding set of search results. Consequently, when a given tile is active, neighboring selectable tiles may correspond to top-ranked search results of each of the distinct search queries. These sets of search results may be ranked using various signals, such as relevance scores, respective measures of popularity, measures of quality of selectable tiles generated from underlying documents, and so forth.

As noted above, the multiple distinct searches can be formulated based on various attributes of the document underlying the in-focus tile. Because these search queries are distinct from each other, they effectively seek different types of documents. As a consequence, a user can navigate along one axis in one or more directions (e.g., up/down) to explore one type of document (e.g., a first train of thought or research thread), and can navigate along another axis in one or more directions (e.g., left/right) to explore another type of document (e.g., a second train of thought or research thread).

In some implementations, a search query for a given axis may be formulated to include one or more topics associated with the document corresponding to the in-focus selectable tile. For example, if an in-focus selectable tile links to an article about basketball, one or more neighboring tiles may correspond to documents that also relate to the topic of “basketball.” In some implementations, different neighboring tiles may correspond to documents of differently-scoped topics having different document relationships with the in-focus document. Continuing the same example, one neighboring tile may also relate to the relatively specific topic of basketball, whereas another neighboring tile may relate to sports generally (and may be about another sport such as football).

In some implementations, a search query for a given axis may be formulated to include a publisher or author of the document corresponding to the in-focus selectable tile. For example, a user may navigate up or down to explore other documents published by the same magazine or website, or written by the same author, as the document corresponding to the currently in-focus tile.

In some implementations, a search query for a given axis may seek documents with sentiments or viewpoints that contrast with a sentiment or viewpoint of the document corresponding to the in-focus selectable tile. For example, a user may navigate up to see like-minded opinion piece(s) and down to see contrasting opinion piece(s). In some implementations, a search query for a given axis may include one or more entities mentioned in the document corresponding to the in-focus selectable tile. For example, a user could navigate to neighboring tiles to explore documents about entities mentioned in the document corresponding to the in-focus tile, or with entities that are related thereto in a knowledge graph.

In some implementations, neighboring selectable tiles may be generated without necessarily formulating new search queries. For example, neighboring selectable tiles may be generated that correspond to hyperlinks contained in the document that is currently in focus. For example, the currently in-focus document may include a number of other hyperlinks to related documents. Neighboring selectable tiles along one or more axes from the in-focus selectable tile may be generated from some number of these linked-to documents, e.g., based on their respectively popularities, etc. However, and as noted above, techniques described herein are not limited to providing neighboring tiles that correspond to hyperlinks of the in-focus document. For example, some neighbor tiles may lead to documents and/or other information that the user may never have thought of exploring.

In various implementations, neighboring selectable tiles may be refreshed each time the GUI's focus is shifted to a new selectable tile, every other time the focus is shifted, or some variation thereof. In some implementations, selectable tiles that the lie in the direction of movement of the focus on the same axis are not refreshed so long as the focus is kept moving along the same axis. For example, selectable tiles along the axis may correspond to a ranked list of documents returned from one of the aforementioned pseudo queries. So long as the user keeps navigating the focus along the same axis (in either direction), the selectable tiles along that axis may remain the same, allowing the user to effectively browse through a list of ranked search results. By contrast, selectable tiles along other axes may be refreshed periodically, at every turn, as needed, etc.

In some implementations, a computer implemented method may be provided that includes: generating, for rendition on a display, a GUI that is operable to navigate a focus of the GUI through an array of selectable tiles along multiple axes, wherein each of the selectable tiles is selectable to access a respective document available from an online corpus; based on directional input, shifting the focus of the GUI in a direction of the directional input from a first selectable tile of the array to a second selectable tile of the array; in response to the directional input, formulating at least first and second distinct search queries based on the document corresponding to the second selectable tile or to a third selectable tile beyond the second selectable tile; obtaining a first set of one or more documents that are responsive to the first search query; obtaining a second set of one or more documents that are responsive to the second search query; and generating an updated GUI, wherein the updated GUI includes: a first backgrounded selectable tile along a first axis of the multiple axes from the second selectable tile, wherein the first backgrounded selectable tile corresponds to a document of the first set; and a second backgrounded selectable tile along a second axis of the multiple axes from the second selectable tile, wherein the second backgrounded selectable tile corresponds to a document of the second set.

This method and other implementations of technology disclosed herein may each optionally include one or more of the following features.

In various implementations, the updated GUI further includes, along one of the multiple axes from the second selectable tile in a reverse of the direction, a backgrounded tile that corresponds to the first tile.

In various implementations, the selectable tile that is the focus of the GUI or the updated GUI is foregrounded relative to other selectable tiles of the array. In various implementations, the updated GUI may include two or more directional navigation elements accompanying the second selectable tile, each of the two or more directional navigation elements being operable to navigate the focus of the GUI along a corresponding axis of the multiple axes from the second selectable tile to a respective neighbor selectable tile.

In various implementations, the first search query may include one or more topics associated with the document corresponding to the second selectable tile. In various implementations, the first search query may include a publisher of the document corresponding to the second selectable tile. In various implementations, the first search query may seek documents with sentiments or viewpoints that contrast with a sentiment or viewpoint of the document corresponding to the second selectable tile.

In various implementations, the first search query may include one or more entities mentioned in the document corresponding to the second selectable tile. In various implementations, the first search query may include one or more entities that are related, in a knowledge graph, with an entity mentioned in the document corresponding to the second selectable tile. In various implementations, the first set of one or more documents may include multiple documents that are ranked based on respective measures of popularity. In various implementations, the first set of one or more documents may include multiple documents that are ranked based on respective measures of quality of selectable tiles generated from the multiple documents of the first set.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which selected aspects of the present disclosure may be implemented.

FIGS. 2A, 2B, and 2C depict one example of how a GUI generated using disclosed techniques may appear when operated, in accordance with various implementations.

FIG. 3 depicts one example of how backgrounded selectable tiles may be generated preemptively, in accordance with various implementations.

FIGS. 4, 5, and 6 depict example selectable tile layouts of various multi-axis GUIs.

FIG. 7 depicts an example method for practicing selected aspects of the present disclosure.

FIG. 8 illustrates an example architecture of a computer system.

### DETAILED DESCRIPTION

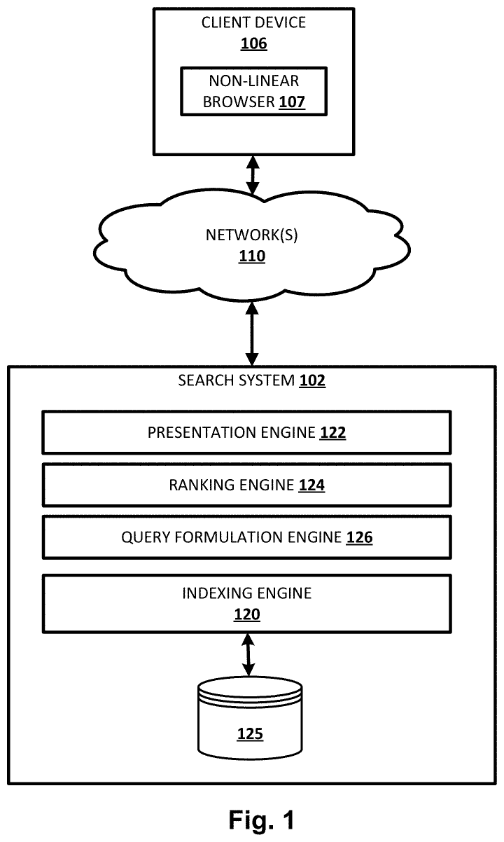

FIG. 1 illustrates an example environment in which selected aspects of the present disclosure can be implemented. The example environment includes a client device 106 and a search system 102. Search system 102 may be implemented in one or more computers that communicate, for example, through one or more additional networks (not depicted). Search system 102 is an example of an information retrieval system in which at least portions of the systems, components, and techniques described herein may be implemented and/or with which systems, components, and techniques described herein may interface.

A user may interact with search system 102 via client device 106. Search system 102 receives search queries from the client device 106 and returns search results in response to the search queries. Each search query is a request for information. A search query can be, for example, in a text form and/or in other forms such as, for example, audio form and/or image form. Other computer devices may submit search queries to the search system 102 such as additional client devices and/or one or more servers implementing a service for a website that has partnered with the provider of the search system 102. For brevity, however, the examples are described in the context of client device 106.

Client device 106 may be a computer coupled to the search system 102 through a network 110 such as a local area network (LAN) or wide area network (WAN) such as the Internet. The client device 106 may be, for example, a desktop computing device, a laptop computing device, a tablet computing device, a mobile phone computing device, a computing device of a vehicle of the user (e.g., an in-vehicle communications system, an in-vehicle entertainment system, an in-vehicle navigation system), or a wearable apparatus of the user that includes a computing device (e.g., a watch of the user having a computing device, glasses of the user having a computing device), a standalone display/speaker combination, and so forth. Additional and/or alternative client devices may be provided.

The client device 106 typically includes one or more applications to facilitate submission of search queries and the sending and receiving of data over a network. For example, the client device 106 may execute one or more applications, such as a non-linear browser 107, that allow users to formulate queries and submit the queries to the search system 102. Non-linear browser 107 may also work with component(s) of search system 102 to facilitate rendition of a non-linear graphical user interface (“GUI”) that a user of client device 106 can operate to, for instance, browse documents on the Internet. Non-linear browser 107 and the GUI it generates (e.g., in cooperation with component(s) of search system 102) will be described in more detail shortly.

In some implementations, client device 106 may execute one or more applications, such as non-linear browser 107, that execute instructions provided by the search system 102 to modify search results based on one or more signals. The client device 106 and the search system 102 each include memory for storage of data and software applications, a processor for accessing data and executing applications, and components that facilitate communication over a network. The operations performed by the client device 106 and/or the search system 102 may be distributed across multiple computer systems. The search system 102 may be implemented as, for example, computer programs running on one or more computers in one or more locations that are coupled to each other through a network.

Search system 102 may include an indexing engine 120, a presentation engine 122, a ranking engine 124, and query formulation engine 126. In some implementations one or more of engines 120, 122, 124, and/or 126 may be omitted. In some implementations all or aspects of one or more of engines 120, 122, 124, and/or 126 may be combined. In some implementations, one or more of engines 120, 122, 124, and/or 126 may be implemented in a component that is separate from the search system 102. In some implementations, one or more of engines 120, 122, 124, and/or, or any operative portion thereof, may be implemented in a component that is executed by client device 106.

Indexing engine 120 maintains an index 125 for use by search system 102. The indexing engine 120 processes documents and updates index entries in the index 125, for example, using conventional and/or other indexing techniques. For example, the indexing engine 120 may crawl one or more resources such as the World Wide Web and index documents accessed via such crawling. As another example, the indexing engine 120 may receive information related to one or documents from one or more resources such as web masters controlling such documents and index the documents based on such information. A document is any data that is associated with a document address. Documents include web pages, word processing documents, portable document format (PDF) documents, images, emails, calendar entries, videos, and web feeds, to name just a few. Each document may include content such as, for example: text, images, videos, sounds, embedded information (e.g., meta information and/or hyperlinks); and/or embedded instructions (e.g., ECMAScript implementations such as JavaScript).

In this specification, the term “database” and “index” will be used broadly to refer to any collection of data. The data of the database and/or the index does not need to be structured in any particular way and it can be stored on storage devices in one or more geographic locations. Thus, for example, the index 125 may include multiple collections of data, each of which may be organized and accessed differently.

Presentation engine 122 may be configured to provide, to client device 106, data that enables non-linear browser 107 to render a GUI in accordance with various aspects of the present disclosure. For example, presentation engine 122 may provide information that allows non-linear browser 107 to render a multi-axis GUI of selectable tiles as will be described below. In some cases presentation engine 122 may generate the selectable tiles itself and then send renderable data indicative thereof to non-linear browser 107. In other instances, presentation engine 122 may transmit list(s) of search results to non-linear browser 107, and non-linear browser 107 may generate the multi-axis GUI and/or selectable tiles thereof itself. These list(s) of search results may be generated based on submission of pseudo search queries that are formulated by query formulation engine 126, as will be described shortly.

Ranking engine 124 may use index 125 to identify documents and other information responsive to a search query, for example, using conventional and/or other information retrieval techniques. Ranking engine 124 may calculate scores for the documents and other information identified as responsive to the search query, for example, using one or more ranking signals. Each ranking signal may provide information about the document or information itself, the relationship between the document or information and the search query 104, and/or the relationship between the document or information and the user performing the search. Ranking signals may include, for instance, a popularity of a document (e.g., relative to other documents), a number of other documents that link to a particular document, the number of links in the document, etc. As will be described below, rankings or scores assigned by ranking engine 124 may be used to determine which selectable tiles should be presented in non-linear browser 107 as neighbors of the currently in-focus, foregrounded selectable tile.

Query formulation engine 126 may be configured to formulate the aforementioned pseudo or background queries that are used to retrieve documents for use in generating selectable tiles along multiple axes of the GUI rendered by non-linear browser 107. These pseudo queries may be formulated based on a variety of signals. Many of these signals may be determined based on a document underlying (e.g., that is retrievable by interacting with) a currently in-focus selectable tile. For the sake of brevity, this document will be referred to as the “in-focus” document.

In some implementations, one or more topics associated with the in-focus document may be used to formulate one or more pseudo queries. These topics may be determined, for instance, based on metadata associated with the document, topic(s) previously ascertained from the document by indexing engine 120 during document crawling, from topic analysis techniques such as natural language processing, topic modeling, and/or topic classification, from user-submitted topics (e.g., crowdsourced), term frequency-inverse document frequency (“TD-IDF”) analysis, and so forth. Topics can vary widely and can include entities (people, places, things) that are mentioned in or otherwise related to the in-focus document.

In some implementations, other attributes of the in-focus document can be used by query formulation engine 126 to formulate pseudo queries. These other attributes may include, for instance, a publisher of the in-focus document. A publisher can be a periodical such as a newspaper or magazine, a website (which itself may be controlled by a newspaper or magazine), a “news aggregator,” a book publisher, a music publisher, a film studio, a television station, and so forth. Thus, for instance, a pseudo search may be performed for other documents published or otherwise associated with the same publisher as the in-focus document. The results of such a search may be ranked, e.g., by ranking engine 124, and then used to generate one or more selectable tiles along one or more axes of the multi-axis GUI rendered by non-linear browser 107. Consequently, a user viewing one article by a publisher can easily transition a focus of multi-axis GUI rendered by non-linear browser 107 to a neighboring selectable tile that is selectable to view another document associated with the same publisher.

A pseudo search query may also seek documents with viewpoints that contrast with a sentiment of the in-focus document. Suppose the in-focus document espouses a view point from a first political position. One pseudo search may be formulated, e.g., by query formulation engine 126, that seeks other documents espousing a similar view point. Another pseudo search may be formulated, e.g., by query formulation engine 126, that seeks other documents espousing a contrasting view point. Consequently, a user viewing the first document can easily transition a focus of multi-axis GUI rendered by non-linear browser 107 to one neighboring selectable tile to view another document having a similar view point. The user can also transition the focus of multi-axis GUI to another neighboring selectable tile along a different axis (e.g., 180 degrees from the first axis) to view another document having a contrasting view point.

Similarly, a pseudo search query may also seek documents with sentiments that contrast with a sentiment of the in-focus document. Suppose the in-focus document is a positive review of a film. One pseudo search may be formulated, e.g., by query formulation engine 126, that seeks other positive reviews of the film (or other positive reviews from the same reviewer, etc.). Another pseudo search may be formulated, e.g., by query formulation engine 126, that seeks negative reviews of the film (or negative reviews by the same reviewer, etc.). Consequently, a user viewing the first review can easily transition a focus of multi-axis GUI rendered by non-linear browser 107 to one neighboring selectable tile to view another positive review and to another neighboring selectable tile along a different axis (e.g., 180 degrees from the first axis) to view a negative review of the film.

Pseudo searches may also be formulated, e.g., by query formulation engine 126, based on one or more entities that are mentioned in the in-focus document. For example, other documents may be sought that mention, are about, or otherwise are associated with an entity mentioned in the in-focus document. In some implementations, query formulation engine 126 may formulate a pseudo query that includes one or more entities that are related, e.g., in a knowledge graph, with an entity mentioned in the in-focus document.

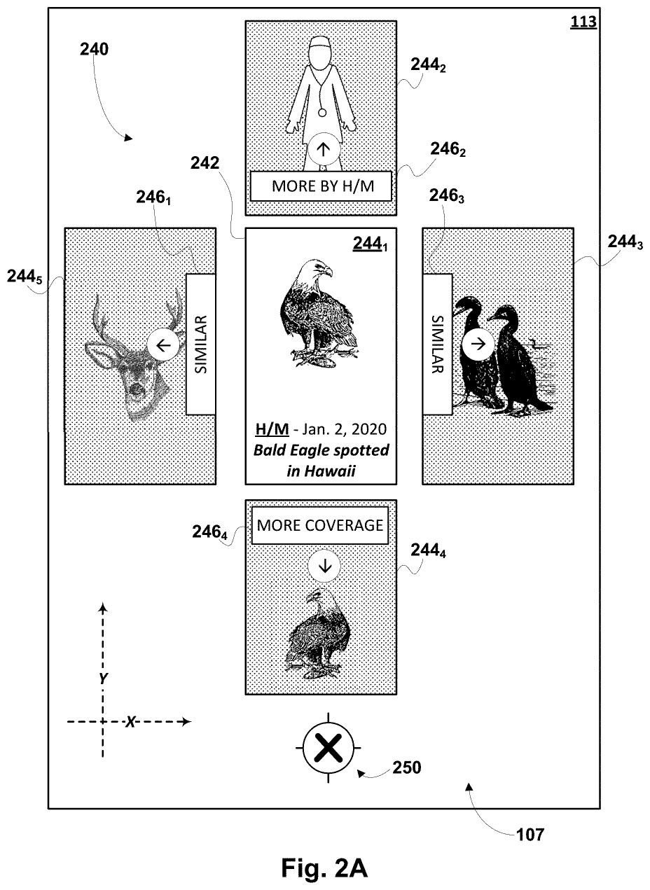

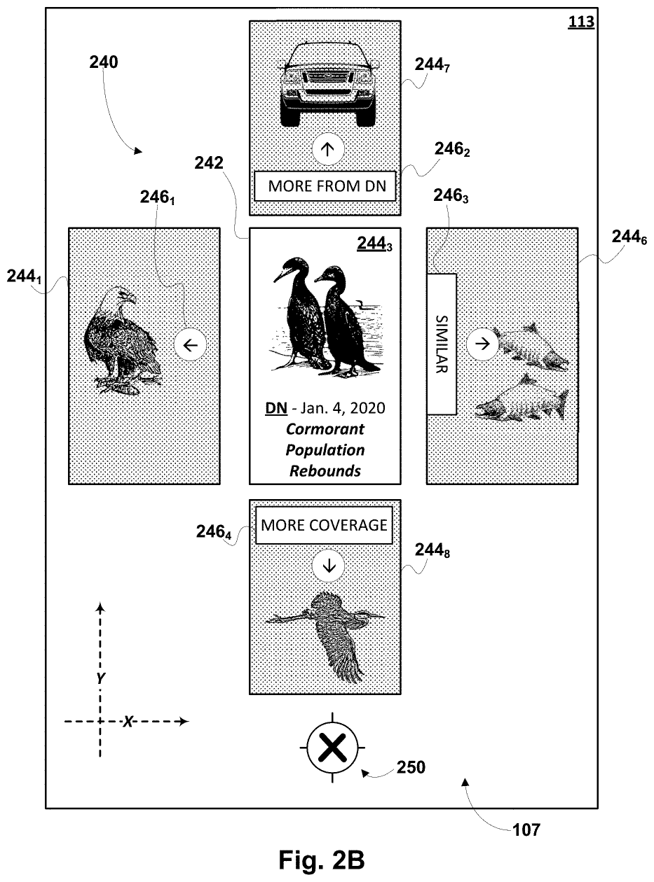

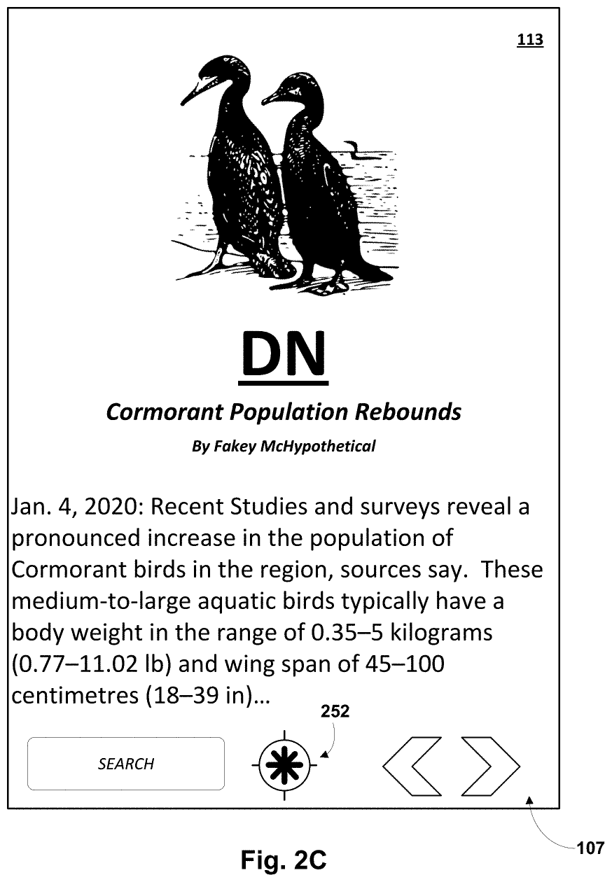

FIG. 2A depicts an example display 113 that may be part of, for instance, client device 106 (which is not depicted in FIGS. 2A-C for the sake of brevity). In some implementations, display 113 may be a touchscreen display, although this is not required. Rendered on display 113, e.g., by non-linear browser 107, is an example of a multi-axis GUI 240 that is generated and configured with selected aspects of the present disclosure. Multi-axis GUI 240 includes a plurality of selectable tiles 244₁₋₅. One selectable tile 244₁ is currently the focus 242 of multi-axis GUI 240. Multi-axis GUI 240 also includes a graphical element 250 that is selectable by a user to exit the multi-axis GUI 240 and transition to, for instance, a traditional web browser.

As used herein, the “focus” 242 of multi-axis GUI 240 refers to the element of GUI 240 that is presented in a manner meant to draw a user's attention the element. For example, a particular selectable tile-244₁ in FIG. 2A—that currently is the focus 242 may be “foregrounded” relative to other selectable tiles 244₂₋₅. A selectable tile may be “foregrounded” relative to other selectable tiles in various ways, such as being rendered larger than or more clearly/conspicuously than other tiles, centered on the screen (with other tiles in the margins), occupying the majority of the screen (whereas other tiles occupy only the margins), etc. In some implementations, the selectable tile that is the focus of GUI 240 may be rendered relatively clearly, whereas other tiles (or at least the visible portions thereof) and/or GUI elements may be rendered slightly blurred.

In some implementations, if a user were to select the in-focus selectable tile 244₁—e.g., by tapping on it, clicking it with a mouse, or issuing a voice command to select it—GUI 240 may transition into a new state (similar to that depicted in FIG. 2C) in which a document underlying that selectable tile 244₁ may be presented to the user for consumption. By contrast, if the user were to select an out-of-focus selectable tile—such as by tapping, clicking, or otherwise selecting any of 244₂₋₅—multi-axis GUI 240 may transition its focus 242 to the newly-selected tile 244. Meanwhile, one or more new pseudo searches may be formulated, e.g., by query formulation engine 126, to generate new list(s) of search results. These new list(s) of search results may then be used to generate new neighboring selectable tile(s) for the newly-in-focus selectable tile 244.

In FIG. 2A, the focus 242 of multi-axis GUI 240 is on a selectable tile 244₁ that links to an article from the publisher Hypothetical Media (“H/M” in FIG. 2A) entitled “Bald Eagle spotted in Hawaii.” Neighboring selectable tiles 244 along each of the axes (X and Y in FIG. 2A) link to documents that are related to this in-focus document in various ways, as indicated by directional navigation elements 246₁₋₄. For example, first directional navigation element 246₁ points to the left along the X axis to a “similar” document that is represented by selectable tile 244s. The document underlying selectable tile 244s may be similar to the in-focus document underlying selectable tile 244₁ by virtue of both of them relating to animals or wildlife.

Second directional navigation element 246₂ points up along the Y axis to more document(s) by the same publisher (“more by H/M”) underlying selectable tile 244₂. Third directional navigation element 246₃ points right along the X axis to more similar document(s) (e.g., documents relating specifically to birds, not just wildlife in general) underlying selectable tile 244₃. Fourth directional navigation element 246₄ points down along the Y axis to more document(s) underlying selectable tile 244₄ that provide the same coverage related to the bald eagle being spotted in Hawaii. In some implementations, these relationships to the in-focus document underlying the currently in-focus selectable tile 244₁ may be set by a user, e.g., based on their preferences. For example, some users may prefer the relationships represented along the various axes be arranged differently, or replaced with other relationships.

FIG. 2B depicts multi-axis GUI 240 after a user has shifted focus 242 from selectable tile 244₁ to selectable tile 244₃, right along the X-axis, e.g., by swiping right, clicking directional navigation element 246₃, tapping selectable tile 244₃, etc. In FIG. 2B, previously-in-focus selectable tile 244₁ is now backgrounded to the left of focus 242. Directional navigation element 246₁ now simply indicates a back arrow, rather than a relationship like the other directional navigation elements 246₂₋₄. This back arrow may be intuitive for the user, who may be accustomed to operating a back arrow as part of a traditional web browser.

Selectable tile 244₃ is selectable to open a document entitled “Cormorant Population Rebounds” by a hypothetical publisher called “Daily News,” or “DN” in FIG. 2B. And the selectable tiles other than 244₁ have been updated based on this document, e.g., by formulating pseudo queries as described previously. As before, directional navigation element 246₄ that points down along the Y-axis leads to more coverage of the same story in the form of a new selectable tile 244₈. Now, however, because the in-focus story has changed, more coverage leads to other documents about the cormorant bird, rather than more coverage about the bald eagle in Hawaii (as was the case in FIG. 2A). Right-pointing directional navigation element 246₃ leads to other similar documents, which in this case leads to a new selectable tile 244₆ that links to a story related to fish. Up-pointing directional navigation element 246₂ now leads to a selectable tile 244₇ that links to another document by Daily News.

FIG. 2C depicts what might happen if the user selects selectable tile 244₃ in FIG. 2B. The Cormorant article has expanded to occupy the majority of display 113, enabling the user to read the article. Also depicted in FIG. 2C is a search field and back and forward arrows, as well as a graphical element 252 that is operable to transition back into the multi-axis GUI 240 of FIG. 2B.

Multi-axis GUI 240 of FIGS./2A-B is just one example of how techniques described herein may be implemented to provide a user with a less linear document browsing experience. Multi-axis GUIs configured and/or generated with selected aspects of the present disclosure may take myriad other forms. In some implementations, users may be able to configure various parameters of these multi-axis GUIs, such as how many axes are provided, how many selectable tiles are provided per axis, what relationships are represented along each axis in each direction, etc.

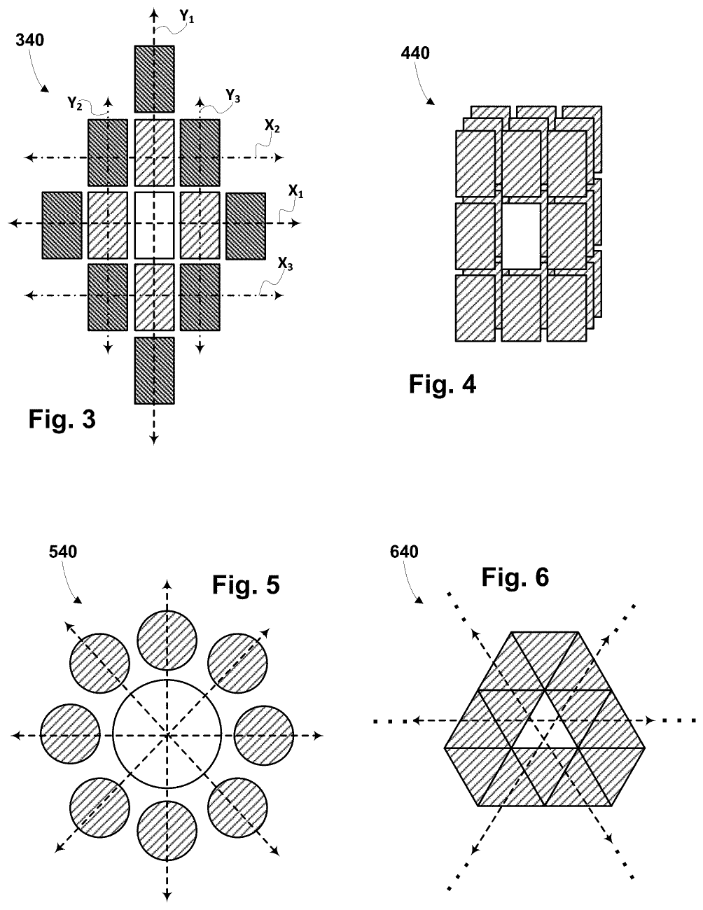

FIG. 3 depicts a slight variation of multi-axis GUI 240 of FIGS. 2A-B. In FIG. 3, a multi-axis GUI 340 once again allows the user to navigate a focus (white selectable tile in the middle) of GUI 340 left, right, up, or down. In some cases, multi-axis GUI 340 may appear to the user similarly as multi-axis GUI 240 as the user may only see the in-focus selectable tile (white in the middle) and the four neighboring tiles that are intermediately shaded in FIG. 3. (“Neighboring tiles” will be used to refer to tiles that are immediately adjacent the in-focus tile). However, GUI 300 may pre-load or pre-fetch documents and/or corresponding selectable tiles beyond the nearest neighboring tiles. Put another way, the pseudo searches performed by query formulation engine 126 may pre-populate selectable tiles beyond the directly-adjacent neighbors of the currently-in-focus selectable tile.

To demonstrate, suppose the middle tile in FIG. 3 has just been made the focus (242 in FIGS. 2A-B) of multi-axis GUI 340. New pseudo searches may be formulated, e.g., by query formulation engine 126, to proactively generate the darkest selectable tiles at the perimeter of multi-axis GUI 340. For example, the currently-visible selectable tiles may be the innermost three tiles along the main X axis X₁ and the innermost three tiles of the main Y axis Y₁. However, additional selectable tiles (which may or may not be visible to the user) may be pre-generated along secondary X and Y axes X₂, X₃, Y₂, and Y₃.

In some implementations, these additional selectable tiles may be pre-generated based on documents underlying neighboring selectable tiles (intermediately shaded in FIG. 3), rather than based on the in-focus document underlying the in-focus selectable tile in the middle. This enables more distant selectable tiles (and their underlying documents) to be pre-fetched, decreasing latency for the user.

For example, the selectable tiles at top and bottom of the Y₂ axis may be pre-generated based on content of the document underlying the selectable tile immediately to the left of the in-focus middle selectable tile along the primary X axis X₁. If the same axis relationships as FIGS. 2A-B are used, the document up the Y₂ axis may be more by the same publisher and the document down the Y₂ axis may be more coverage of the same story. Similarly, the selectable tiles at top and bottom of the Y₃ axis may be pre-generated based on content of the document underlying the selectable tile immediately to the right of the in-focus middle selectable tile along the primary X axis X₁. And so on.

Notably, some implementations, pre-generated selectable tiles may lie on multiple different axes associated with multiple different relationships. For example, the selectable tile at top of the Y₂ axis is also the leftmost selectable tile of the X₂ axis. In some implementations, to populate such a tile, a query may be formulated, e.g., by query formulation engine 126, that includes search terms that are relevant for both axes' relationships. For example, and again assuming the same axis relationships are used as were present in FIGS. 2A-B, up may direct to more documents from the same publisher and left may direct to more documents that are similar to the in-focus document. Accordingly, the darkly shaded tile at the top of the Y₂ axis in FIG. 3 may be generated from a search query that seeks documents that are both from (i) the same publisher as the document underlying the left intermediately shaded neighbor tile on the main X axis X₁, and (ii) relate to similar subject matter as the document underlying the top neighbor tile along the main Y axis Y₁.

Multi-axis GUIs are not limited to two dimensions as depicted in FIGS. 2A-B and 3. In some implementations a multi-axis GUI may include selectable tiles along more than two dimensions. For example, FIG. 4 schematically depicts an example multi-axis GUI 440 with three dimensions. In this example, the user may shift the focus (currently on the middle unshaded tile) to other tiles on the same plane (i.e., the plane closest to the user) or on a different plane behind the main plain. And each axis may once again represent a different relationship to the currently-in-focus document.

Two-dimensional GUIs configured and/or generated with selected aspects of the present disclosure are not limited to the rectangular tiles and/or perpendicular axes shown in FIGS. 2A-B and 3. For example, a two-dimensional GUI 540 depicted in FIG. 5 includes non-rectangular selectable tiles in the form of circles. These circular selectable tiles are arranged along four non-perpendicular axes to surround a currently in-focus circular selectable tile. Also, the neighboring circular tiles (shaded) are rendered smaller than the in-focus circular tile (unshaded), although this is not required. FIG. 6 depicts another example GUI 640 with non-rectangular selectable tiles and non-perpendicular axes. In this example, each selectable tile takes the form of a triangle. The unshaded in-focus tile is surrounded by neighboring triangular tiles along three different axes.

The examples of FIGS. 2-6 provided for illustrative purposes and are not meant to be limiting. Any of these example GUIs may be rendered on a two dimensional display (e.g., a touchscreen of a smart phone or tablet, a projection screen, etc.), or on other types of displays. For example, any of these multi-axis GUIs may be rendered by a head-mounted display, e.g., on one eye's display or on both eye's displays. In some such implementations, a user may change the focus of the multi-axis GUI using their voice, by shifting their gaze to a neighboring selectable tile, by making a gesture (e.g., a wave right to move the focus right), and so forth.

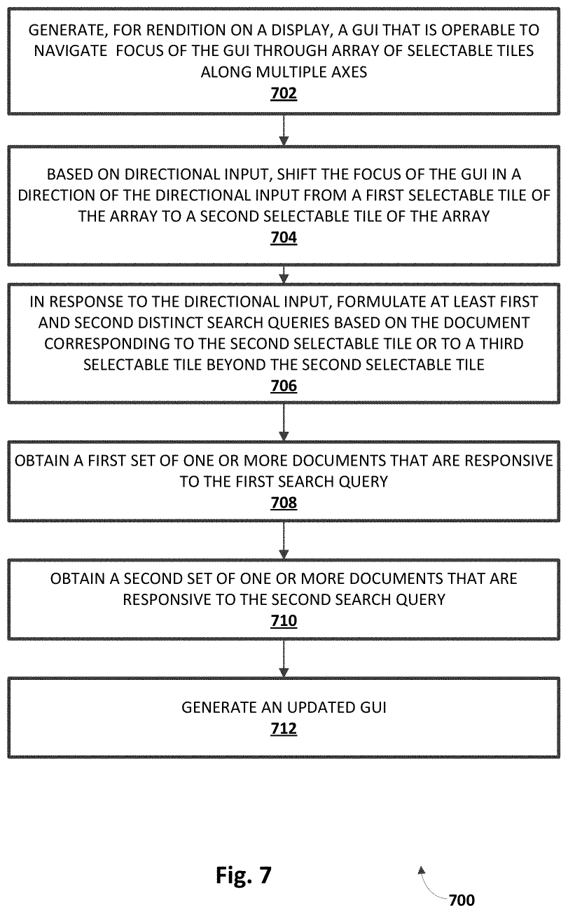

FIG. 7 illustrates a flowchart of an example method 700 for practicing selected aspects of the present disclosure. The operations of FIG. 7 can be performed by one or more processors, such as one or more processors of the various computing devices/systems described herein. For convenience, operations of method 700 will be described as being performed by a system configured with selected aspects of the present disclosure. Other implementations may include additional operations than those illustrated in FIG. 7, may perform operation(s) of FIG. 7 in a different order and/or in parallel, and/or may omit one or more of the operations of FIG. 7.

At block 702, the system may generate, for rendition on a display, a multi-axis GUI that is operable to navigate a focus of the GUI through an array of selectable tiles along multiple axes. Each of the selectable tiles may be selectable to access a respective document available from an online corpus.

At block 704, the system may, based on directional input, shift the focus of the GUI in a direction of the directional input from a first selectable tile of the array to a second selectable tile of the array that is a neighbor to the first selectable tile. For example, if the directional input indicates up, then the focus of the multi-axis GUI may be shifted from the currently in-focus selectable tile to its neighbor above it. If the directional input indicates into the screen (along a normal of the screen with a 3D GUI like GUI 440), then the tile immediately behind the currently in-focus selectable tile may become the focus of the GUI. And so on.

In response to the directional input, at block 706, the system may formulate one or more distinct search queries based on the document corresponding to the second selectable tile or to a third selectable tile beyond the second selectable tile. For example, if the user shifts the GUI's focus to a new tile relating to a particular basketball team, one search may be performed for other general basketball-related documents and another search may be performed for other documents associated with the particular basketball team. In other implementations, a pseudo search may be performed for only those selectable tiles that lie along axes other than the axis the user just navigated (i.e., so long as the user keeps the focus on the same axis, the user can navigate through the same (e.g., ranked) list of documents.

At block 708, the system may obtain a first set of one or more documents that are responsive to the first search query. In some implementations, at optional block 710, the system may obtain a second set of one or more documents that are responsive to the second search query. In other implementations, only search(s) to populate non-navigated axes are performed as described previously. At block 712, the system may generate an updated GUI.

As described and illustrated herein, the updated GUI may include a first backgrounded selectable tile along a first axis of the multiple axes from the second selectable tile. The first backgrounded selectable tile may correspond to a document of the first set. And, if the operations of block 710 were performed, the updated GUI may also include a second backgrounded selectable tile along a second axis of the multiple axes from the second selectable tile. The second backgrounded selectable tile may correspond to a document of the second set. As was shown with selectable tile 244₁ in FIG. 2B, in some implementations, the updated GUI further includes, along one of the multiple axes from the second selectable tile in a reverse of the direction indicated in the directional input, a backgrounded tile that corresponds to the first tile.

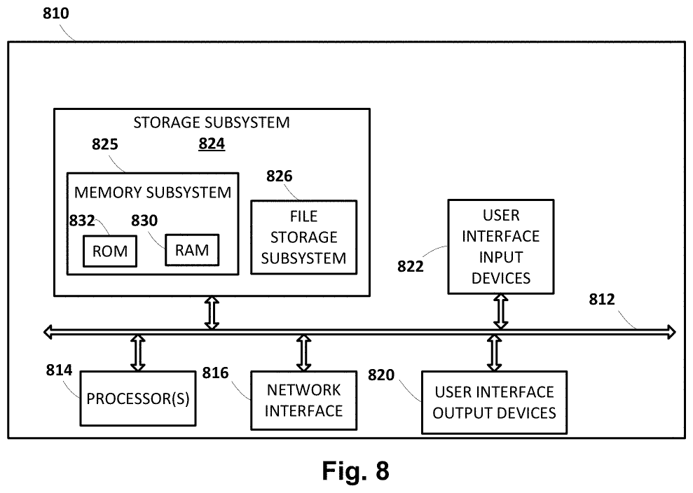

FIG. 8 is a block diagram of an example computer system 810. Computer system 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computer system 810. Network interface subsystem 816 provides an interface to outside networks and is coupled to corresponding interface devices in other computer systems.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image (e.g., a head-mounted display or augmented reality device). The display subsystem may also provide non-visual display such as via audio output devices. In general, use of the term “output device” is intended to include all possible types of devices and ways to output information from computer system 810 to the user or to another machine or computer system.

Storage subsystem 824 stores programming and data constructs that provide the functionality of some or all of the modules described herein. For example, the storage subsystem 824 may include the logic to perform selected aspects of method 700.

These software modules are generally executed by processor 814 alone or in combination with other processors. Memory 825 used in the storage subsystem can include a number of memories including a main random access memory (RAM) 830 for storage of instructions and data during program execution and a read only memory (ROM) 832 in which fixed instructions are stored. A file storage subsystem 824 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 824 in the storage subsystem 824, or in other machines accessible by the processor(s) 814.

Bus subsystem 812 provides a mechanism for letting the various components and subsystems of computer system 810 communicate with each other as intended. Although bus subsystem 812 is shown schematically as a single bus, alternative implementations of the bus subsystem may use multiple busses.

Computer system 810 can be of varying types including a workstation, server, computing cluster, blade server, server farm, or any other data processing system or computing device. Due to the ever-changing nature of computers and networks, the description of computer system 810 depicted in FIG. 8 is intended only as a specific example for purposes of illustrating some implementations. Many other configurations of computer system 810 are possible having more or fewer components than the computer system depicted in FIG. 8.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors, comprising:
generating, for rendition on a display, a graphical user interface (“GUI”) that is operable to navigate a focus of the GUI through an array of selectable tiles along multiple axes, wherein each of the selectable tiles is selectable to access a respective document available from an online corpus;
based on directional input, shifting the focus of the GUI in a direction of the directional input from a first selectable tile of the array to a second selectable tile of the array;
in response to the directional input, formulating at least first and second distinct search queries based on the document corresponding to the second selectable tile or to a third selectable tile beyond the second selectable tile;
obtaining a first set of one or more documents that are responsive to the first search query;
obtaining a second set of one or more documents that are responsive to the second search query; and
generating an updated GUI, wherein the updated GUI includes:
a first backgrounded selectable tile along a first axis of the multiple axes from the second selectable tile, wherein the first backgrounded selectable tile corresponds to a document of the first set; and
a second backgrounded selectable tile along a second axis of the multiple axes from the second selectable tile, wherein the second backgrounded selectable tile corresponds to a document of the second set.

2. The method of claim 1, wherein the updated GUI further includes, along one of the multiple axes from the second selectable tile in a reverse of the direction, a backgrounded tile that corresponds to the first tile.

3. The method of claim 1, wherein the selectable tile that is the focus of the GUI or the updated GUI is foregrounded relative to other selectable tiles of the array.

4. The method of claim 1, wherein the updated GUI includes two or more directional navigation elements accompanying the second selectable tile, each of the two or more directional navigation elements being operable to navigate the focus of the GUI along a corresponding axis of the multiple axes from the second selectable tile to a respective neighbor selectable tile.

5. The method of claim 1, wherein the first search query includes one or more topics associated with the document corresponding to the second selectable tile.

6. The method of claim 1, wherein the first search query includes a publisher of the document corresponding to the second selectable tile.

7. The method of claim 1, wherein the first search query seeks documents with sentiments or viewpoints that contrast with a sentiment or viewpoint of the document corresponding to the second selectable tile.

8. The method of claim 1, wherein the first search query includes one or more entities mentioned in the document corresponding to the second selectable tile.

9. The method of claim 1, wherein the first search query includes one or more entities that are related, in a knowledge graph, with an entity mentioned in the document corresponding to the second selectable tile.

10. The method of claim 1, the first set of one or more documents includes multiple documents that are ranked based on respective measures of popularity.

11. The method of claim 1, the first set of one or more documents includes multiple documents that are ranked based on respective measures of quality of selectable tiles generated from the multiple documents of the first set.

12. At least one non-transitory computer-readable medium comprising instructions that, in response to execution of the instructions by one or more processors, cause the one or more processors to:
generate, for rendition on a display, a graphical user interface (“GUI”) that is operable to navigate a focus of the GUI through an array of selectable tiles along multiple axes, wherein each of the selectable tiles is selectable to access a respective document available from an online corpus;
based on directional input, shift the focus of the GUI in a direction of the directional input from a first selectable tile of the array to a second selectable tile of the array;
in response to the directional input, formulate at least first and second distinct search queries based on the document corresponding to the second selectable tile or to a third selectable tile beyond the second selectable tile;
obtain a first set of one or more documents that are responsive to the first search query;
obtain a second set of one or more documents that are responsive to the second search query; and
generate an updated GUI, wherein the updated GUI includes:
a first backgrounded selectable tile along a first axis of the multiple axes from the second selectable tile, wherein the first backgrounded selectable tile corresponds to a document of the first set; and
a second backgrounded selectable tile along a second axis of the multiple axes from the second selectable tile, wherein the second backgrounded selectable tile corresponds to a document of the second set.

13. The at least one non-transitory computer-readable medium of claim 12, wherein the updated GUI further includes, along one of the multiple axes from the second selectable tile in a reverse of the direction, a backgrounded tile that corresponds to the first tile.

14. The at least one non-transitory computer-readable medium of claim 12, wherein the selectable tile that is the focus of the GUI or the updated GUI is foregrounded relative to other selectable tiles of the array.

15. The at least one non-transitory computer-readable medium of claim 12, wherein the updated GUI includes two or more directional navigation elements accompanying the second selectable tile, each of the two or more directional navigation elements being operable to navigate the focus of the GUI along a corresponding axis of the multiple axes from the second selectable tile to a respective neighbor selectable tile.

16. The at least one non-transitory computer-readable medium of claim 12, wherein the first search query includes one or more topics associated with the document corresponding to the second selectable tile.

17. The at least one non-transitory computer-readable medium of claim 1, wherein the first search query includes a publisher of the document corresponding to the second selectable tile.

18. The at least one non-transitory computer-readable medium of claim 12, wherein the first search query seeks documents with sentiments or viewpoints that contrast with a sentiment or viewpoint of the document corresponding to the second selectable tile.

19. The at least one non-transitory computer-readable medium of claim 12, wherein the first search query includes one or more entities mentioned in the document corresponding to the second selectable tile.

20. A method implemented using one or more processors and comprising:
generate, for rendition on a display, a graphical user interface (“GUI”) that is operable to navigate a focus of the GUI through an array of selectable tiles along multiple axes, wherein each of the selectable tiles is selectable to access a respective document available from an online corpus;
based on directional input, shift the focus of the GUI along a first axis of the multiple axes that corresponds to direction of the directional input, from a first selectable tile of the array to a second selectable tile of the array;
formulate at least one search query based on the document corresponding to the second selectable tile or to a third selectable tile beyond the second selectable tile;
obtain a set of one or more documents that are responsive to the at least one search query; and
generate an updated GUI, wherein the updated GUI includes a backgrounded selectable tile along a second axis of the multiple axes from the second selectable tile, wherein the backgrounded selectable tile corresponds to a document of the set of one or more documents.
